(19) United States
(12) Patent Application Publication
(10) Pub. No.: US 2024/0352548 A1
(43) Pub. Date: Oct. 24, 2024

(54) SYSTEM AND METHOD FOR INTEGRATED WATER TREATMENT AND COOLING IN THE STEEL INDUSTRY

(71) Applicant: SAUDI ARABIAN OIL COMPANY, Dhahran (SA)

(72) Inventors: Faisal B. Almutairi, Dammam (SA); Ali A. Al-Ugla, Khobar (SA)

(73) Assignee: SAUDI ARABIAN OIL COMPANY, Dhahran (SA)

(21) Appl. No.: 18/305,843

(22) Filed: Apr. 24, 2023

(51) Int. Cl. C21C 5/46; C02F 1/00; F27D 17/00

(52) U.S. Cl. CPC C21C 5/4646; C02F 1/00; F27D 17/004; C02F 2103/16; C02F 2201/009; C02F 2303/10

(57) ABSTRACT

Described is a system for integrated water treatment and cooling in the steel industry. The system includes a waste heat recovery unit, a wastewater treatment system, a water-cooling system, a solar thermal system, and an electric energy production system. The waste heat recovery unit receives waste heat generated by a steelmaking plant. The wastewater treatment system treats wastewater produced by the steelmaking plant and produces treated water. The water-cooling system cools the treated water and returns the cooled treated water to the steelmaking plant for reuse. The solar thermal system collects solar energy, and the electric energy production system generates electricity from the solar energy and the waste heat and uses the generated electricity to power the wastewater treatment system and the water-cooling system.

### BACKGROUND

A steel mill is an industrial plant for the production of steel. Steel production consumes a significant amount of water that is mainly used for cooling purposes. A fresh supply of cooling water is necessary for the operation of the mill due to the extreme temperatures that are present for manufacturing steel. In some geographical areas, water management plays a critical role in the viability of a steel mill due to limited water supply. Water management in a steel mill depends on local conditions, the availability of water, and regulatory requirements. Water consumption of an integrated steel mill may vary from less than 5 cubic meter (m³) per tonne (t) of steel up to 100 m³/t steel. Increasing demands for water resources requires continuous recycling of water in the steel industry.

Electric arc furnace (EAF) steelmaking is the production of steel from scrap or direct reduced iron melted by electric arcs. Approximately one-third of produced steel in the world is manufactured through the EAF process. In EAFs, the material that enters into the furnace for heating is directly exposed to an electric arc. The current from the furnace terminals passes through the charged material. EAF steelmaking allows larger alloy additions than the basic oxygen method and is more energy efficient. However, about one quarter of EAF energy input is released as waste heat, representing approximately 150-200 kilowatt-hour (kWh)/t of liquid steel.

Accordingly, there exists a need for a system and method that utilizes waste process water from a steel mill and cools the water in a low energy, mechanical manner.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for integrated water treatment and cooling in the steel industry. The system comprises a waste heat recovery unit configured for receiving waste heat generated by at least one component of a steelmaking plant; a wastewater treatment system configured for treating wastewater produced by the steelmaking plant and producing treated water; a water-cooling system configured for cooling the treated water and returning cooled treated water to the steelmaking plant for reuse; a solar thermal system configured for collecting solar energy; and an electric energy production system. The electric energy production system is configured for generating electricity from the solar energy and the waste heat. The electric energy production system is further configured for using the generated electricity to power the wastewater treatment system and the water-cooling system.

In another aspect, the water-cooling system is an indirect evaporative based water-cooling system.

In another aspect, the system comprises a cooling water storage tank for storing cooled treated water from the water-cooling system.

In another aspect, the solar thermal system comprises a plurality of solar thermal collectors.

In another aspect, the at least one component is an electric arc furnace (EAF).

In another aspect, the system comprises a power grid configured for storing excess energy from the electric energy production system.

In another aspect, the generated electricity is provided proportionately to the wastewater treatment system and the water-cooling system.

In another aspect, the generated electricity is provided disproportionately to the wastewater treatment system and the water-cooling system.

In another aspect, the system comprises one or more valves for controlling a flow of at least one fluid within the system.

In another aspect, the one or more valves are positioned between the solar thermal system and the electric energy production system.

In another aspect, the one or more valves are positioned between the water-cooling system and the cooling water storage tank.

In another aspect, the system comprises one or more valves for controlling transmission of electricity within the system.

In another aspect, the one or more valves are positioned between the electric energy production system and the power grid.

In another aspect, the one or more valves are positioned between the electric energy production system and the water-cooling system.

In one aspect, embodiments disclosed herein relate to a method for integrated water treatment and cooling in the steel industry. Waste heat generated by at least one component of a steelmaking plant is received with a waste heat recovery unit. Wastewater produced by the steelmaking plant is treated with a wastewater treatment system, thereby producing treated water. The treated water is cooled with a water-cooling system and returned to the steelmaking plant. Solar energy is collected with a solar thermal system. Electricity is generated from the solar energy and the waste heat with an electric energy production system. The generated electricity is then used to power the wastewater treatment system and the water-cooling system.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 is an illustration of a heat recovery process according to one or more embodiments of the present disclosure.

FIG. 2 is an illustration of a system for integrated water treatment and cooling according to one or more embodiments of the present disclosure.

FIG. 3 is an illustration of a method for integrated water treatment and cooling according to one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In one aspect, embodiments disclosed herein relate to an integrated energy system for implementation in the steel industry, which utilizes wastewater and recovered waste energy to produce cooled water and power for a steel mill. The integrated energy system includes a water treatment system and a water-cooling system. These aspects will be described in further detail below.

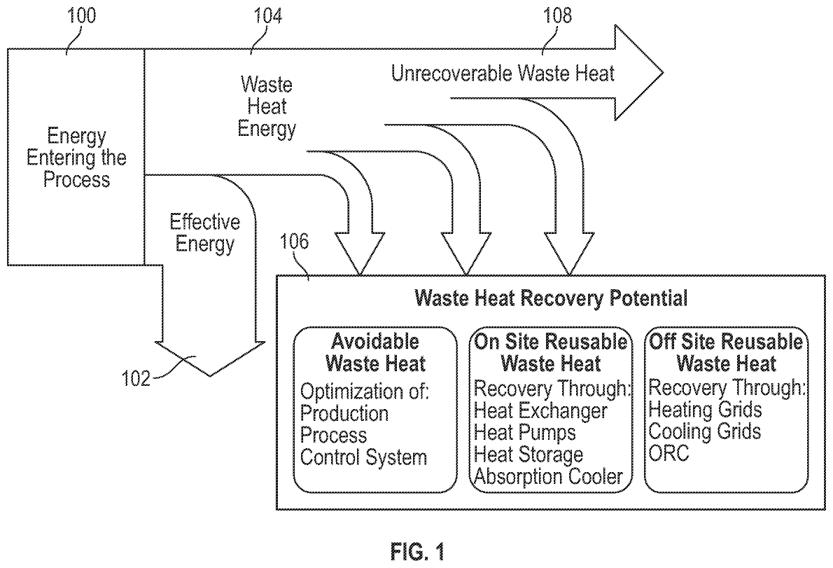

Multiple opportunities for high temperature heat recovery exist in steel mills. FIG. 1 illustrates an example of a heat recovery process. Energy entering a steelmaking process 100 becomes either effective energy 102 or waste heat energy 104. A portion of the waste heat energy has recovery potential 106, while the remaining waste heat energy is considered unrecoverable 108. The recovered waste heat may be used for several applications including, but not limited to, steel production and control of the steel production process. Waste heat may be recovered on-site through electric arc furnaces (EAFs), heat exchangers, heat pumps, heat storage units, and/or absorption coolers at the steel mill. Off-site waste heat may be recovered through heating grids, cooling grids, and/or organic rankine cycle (ORC) systems. The integrated energy system described herein uses one or more alternative sources of energy for power and ensures excess energy is transferred to a power grid for improved energy utilization.

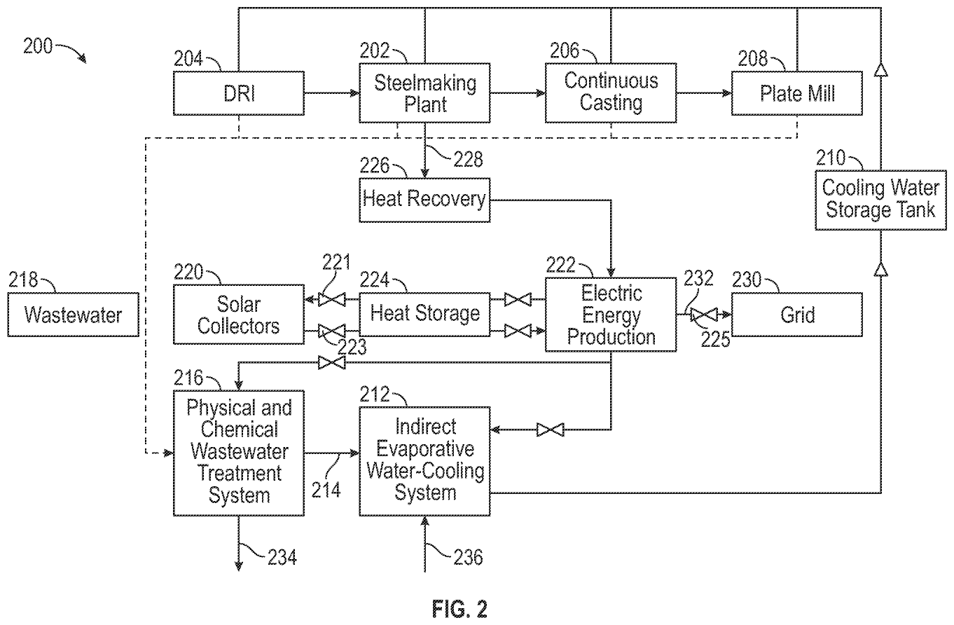

FIG. 2 illustrates the integrated energy system 200 implemented in conjunction with a steelmaking plant 202. The various systems and units of the integrated energy system 200 may be connected and implemented by any suitable configuration of pipes, lines (e.g., transmission lines, stream lines), turbines, reactors, valves, pumps, sensors, drains, tanks, cables, generators, and condensers known by one skilled in the art. As shown, the steelmaking plant 202 may receive direct reduced iron (DRI) 204 from a direct reduction plant. The steelmaking plant 202 produces liquid steel, which may undergo continuous casting 206 in a casting machine. In the continuous casting 206 process, molten metal is allowed to solidify until it becomes a semi-finished slab. A plate mill 208 rolls the semi-finished slab to produce steel plates with varying thicknesses. The described equipment and processes require cool water for several purposes, such as the cooling of furnace walls, steel molds, casting machines, and hot rolling machines. Water is also utilized for cleaning of steel products. In the integrated energy system 200, cooled water is obtained from a cooling water storage tank 210 in connection with the water-cooling system 212.

In one or more embodiments, the water-cooling system 212 is an indirect evaporative based water-cooling system that cools treated water 214 leaving the wastewater treatment system 216. Evaporative cooling is a physical process based on water evaporation. With indirect evaporative cooling, the supply air stream is passively cooled before entering by passing over a medium that has been directly evaporatively cooled. No moisture is added to the supply air stream. In one or more embodiments, the water-cooling system 212 utilizes a copper radiator. A copper radiator cools at approximately 400 Watts per meter-Kelvin (W/mK)), which is optimal for heat transfer between water and air. In one embodiment, the water-cooling system 212 is configured to produce a reduction in temperature of the treated water 214 of about 15° C. to 20° C. Capitalizing on a physical cooling process for the treated water 214 avoids the high cost of traditional air conditioning processes.

Additionally, the integrated energy system 200 reduces water consumption in the steelmaking plant 202 by reusing the wastewater 218 produced by the steelmaking plant 202, which is first treated in the wastewater treatment system 216. Wastewater produced by the DRI 204, continuous casting 206 process, and plate mill 209 may also be recycled. In one or more embodiments, the wastewater treatment system 216 utilizes a combination of physical and chemical separation methods to ensure that quality standards of produced cooling water are met. For instance, acids or alkali may be added after physical processes, such as precipitation and flocculation, to neutralize industrial wastewater.

Solar energy is a free energy source which may be used for several industrial applications, including steel plants. Solar energy may be used to power the integrated energy system 200 in two ways. First, solar energy may be converted into electricity using photovoltaic (PV) cells. The generated electricity may then then be used to operate a conventional EAF system in the steelmaking plant 202. Second, solar energy may be used to heat a working fluid to generate heat for the EAF system. Solar electric systems using PV cells may be more expensive than solar thermal systems. In some embodiments, the integrated energy system 200 uses both a solar thermal system and a waste heat recovery system to meet the power requirements for the EAF process. In one or more embodiments, solar energy and waste heat recovery are utilized simultaneously within the integrated system, as described below.

In one or more embodiments, the integrated energy system 200 includes a solar thermal system having a plurality of solar thermal collectors 220. A solar thermal collector 220 collects heat by absorbing sunlight. The solar thermal collectors 220 may be non-concentrating or concentrating. Non-concentrating collectors have an aperture, or area that receives solar radiation, that is around the same area as the absorber. In contrast, concentrating collectors have an aperture that is larger than the absorber area. Concentrating collectors often require solar tracking due to the movement of the sun. In some embodiments, the solar thermal collectors 220 of the integrated energy system 200 are concentrated heliostat collectors with two-axes tracking.

During daylight hours, thermal heat is collected from the solar thermal collectors 220 and converted to electricity in an electric energy production system 222. In one or more embodiments, the electric energy production system 222 may include one or more of a heat exchanger, a turbine, a heat recovery unit, and an electrical generator. Heat discarded is recovered and then passed through a heat exchanger. The thermal energy is utilized to run a turbine in order to generate electrical energy from the mechanical energy. In one or more embodiments, the solar thermal collectors 220 generate electricity by heating a heat-transfer fluid to drive a turbine connected to an electrical generator.

As shown in FIG. 2, the integrated energy system 200 comprises a plurality of valves represented by two triangles pointing toward each other. Non-limiting examples of valves that may be utilized in the integrated energy system 200 include ball valves, butterfly vales, check valves, control valves, gate valves, plug valves, pressure valves, globe valves, line commutated converter (LCC) valves, and high voltage direct current (HVDC) valves. The valves may be configured to control flow of a fluid, such as a gas or liquid, or transmission of electricity. The integrated energy system 200 is not limited to the arrangement of valves depicted in FIG. 2. As can be appreciated by one skilled in the art, any number and type of valve may be implemented between systems and units of the integrated energy system 200 provided each valve performs its intended control function.

In one or more embodiments, each of the valves is formed to open and close based on conditions present in the integrated energy system 200. For example, the solar thermal collectors 220 may be connected with one or more solar sensors, one or more controllers, and one or more valves 221 and 223. In this embodiment, during daylight hours, one or more of the solar sensors detect sunlight and transmit a signal to the controller indicating the presence of light. The controller is configured to open and close valves 221 and 223 based on the presence or absence of light. During daylight, valves 221 and 223 may be opened by the controller in order to generate electricity for the grid 230. During non-daylight hours, the solar sensors do not detect light, and the controller ensures that valves 221 and 223 are in a closed position. The one or more controllers may be pneumatic, electropneumatic, or digital valve controllers. As can be appreciated by one skilled in the art, any type of controller may be implemented provided that it performs the intended function of controlling one or more valves in the integrated system 200.

Thermal heat that is collected by the solar thermal collectors 220 may be stored in a heat storage unit 224. The solar thermal collectors 220 and the heat storage unit 224 use solar energy to generate electricity during the daytime. The heat storage unit 224 stores heat to be used at a later time, such as during non-daylight hours. The thermal energy may be stored in the heat storage unit 224 as sensible heat, latent heat, or thermo-chemical heat. In one or more embodiments, the heat is stored in sensible form as it is a cost-effective and well-established method of storing heat. The heat storage unit 224 may consist of a two-tank direct storage unit and a heat exchanger. The heat storage unit 224 may be opened during non-daylight hours to ensure continuous operation of the integrated energy system 200.

The electricity generated by the solar thermal collectors 220 may be sent to the power grid 230. However, in an emergency situation, one or more valves 225 along transmission lines that connect the electric energy production system 222 to the grid 230 may be closed. All valves open and close based on one or more conditions (i.e., daylight condition, etc.) and load distribution. The generated electricity may then be directed to feed the wastewater treatment system 216 and the indirect evaporative water-cooling system 212. The electricity generated by the electric energy production system 222 is distributed based on the load required. For instance, the electricity may be disproportionately provided to the wastewater treatment system 216 and the indirect evaporative water-cooling system 212, e.g., 75% to the wastewater treatment system 216 and 25% to the indirect evaporative water-cooling system 212. Alternatively, the electricity may be proportionately provided to the wastewater treatment system 216 and the indirect evaporative water-cooling system 212, such as 50% to the wastewater treatment system 216 and 50% to the indirect evaporative water-cooling system 212.

When solar energy is not available, heat to power the electric energy production system 222 may be recovered from a waste heat recovery unit 226, such as a waste heat recovery boiler. The waste heat recovery unit 226 is configured to transfer waste heat 228 from high temperature process outputs of the steelmaking plant 202, such as the EAF, to the electric energy production system 222 and, thereby, to other equipment and components of the steel plant. By lowering the power demand, the waste heat recovery unit 226 increases efficiency of the steel plant.

An EAF process uses an EAF to melt and refine scrap into new steel. Generally, waste heat 228 exits an EAF at a temperature of about 1204° C. Some of the waste heat 228 is released as flue gas. The flue gases are typically treated and cooled to approximately 250° C. in a flue gas treatment center before being rejected. In the integrated energy system 200, the flue gases are cooled with water from the cooling water storage tank 210. The cooling operation may be combined with energy recovery to produce high quality steam or electricity. The process waste heat 228 is converted to electricity in the electric energy production system 222. The electric energy production system 222 is used to power both the wastewater treatment system 216 and the water-cooling system 212. During the day, both the waste heat 228 from the steelmaking plant 202 and the heat from the solar thermal collectors 220 is converted to electricity through the electric energy production system 222. The waste heat recovery unit 226 is operated during the day and night to power the integrated energy system 200; the solar thermal collectors 220 only operate in the daytime.

Excess energy from the electric energy production system 222 may be transferred to the power grid 230 connected with the electric energy production system 222 for storage and energy optimization. Generally, a power grid 230 is a network of electrical transmission lines connecting multiple generating stations to loads over a wide area. The transmission lines carry electric energy from one point to another in the integrated energy system 200. In an emergency, a transmission line 232 connecting the electric energy production system 222 with the power grid 230 may be shut down when energy is not sufficient to power the water-cooling system 212, as described above.

Power produced by the electric energy production system 222 may be transferred equally between the wastewater treatment system 216 and the water-cooling system 212, such that approximately 50% of the produced power is provided to the wastewater treatment system 216 and approximately 50% of the produced power is provided to the water-cooling system 212. Approximately 75% of the treated water 214 may be provided to the water-cooling system 212. The remaining portion (approximately 25%) of the treated water may be released as black discharge 234. Furthermore, approximately 25% of the required water for the processes performed by the water-cooling system 212 may be obtained as fresh water 236 to ensure a non-contamination process. Thus, a majority of the treated water 214 may be recycled for use in the steelmaking plant 202.

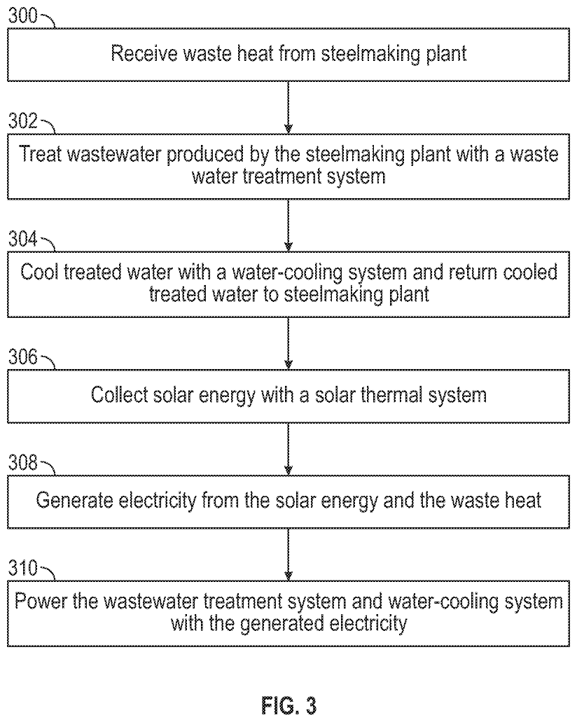

FIG. 3 is a flow diagram illustrating the method for integrated water treatment and cooling according to embodiments of the present disclosure. As described in detail above, waste heat is received from the steelmaking plant 300. Wastewater produced by the steelmaking plant is treated with the wastewater treatment system 302. Additionally, treated water is cooled with the water-cooling system, and the cooled treated water is returned to the steelmaking plant 304. Further, solar energy is collected with a solar thermal system 306. Thereafter, electricity is generated from both the solar energy and the waste heat 308. Finally, the wastewater treatment system and the water-cooling system are powered by the generated electricity 310.

Electricity consumption in steel mills may be reduced tremendously by introducing an on-grid energy conservation system in accordance with embodiments of this disclosure. Furthermore, wastewater may be reused then cooled by employing the integrated energy system described herein. The steel industry contributes to a significant percentage of the world's carbon emissions. The development of an integrated energy optimization, wastewater treatment, and water-cooling system in steel mills as disclosed herein significantly reduces the required cooling water and energy demand while also ensuring utilization of wasted energy and water. The size of collectors may also be reduced making the sustainable and environment friendly integrated system more feasible. The system uses more than one alternative source of energy (e.g., solar energy and heat recovery at the same time) in order to power the integrated system and ensures excessive amount of energy is transferred to the grid for better energy utilization. As can be appreciated by one skilled in the art, the present invention is not limited to the steelmaking industry and may be implemented with any industrial plant that produces waste heat and would benefit from improved energy efficiency and water management.

In one or more embodiments, such an integrated system that reuses most of the wastewater and cools it along with a portion of fresh water, ensuring continues operation with much less water consumption from completely free recycled source of energy within the steel mills as described herein allows for a reduction in carbon emissions in a steel mill 25%, an operational cost reduction by 50%, and utilization of approximately 300,000 m3/year of process wastewater.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for integrated water treatment and cooling in the steel industry, comprising:
a waste heat recovery unit configured for receiving waste heat generated by at least one component of a steelmaking plant;
a wastewater treatment system configured for treating wastewater produced by the steelmaking plant and producing treated water;
a water-cooling system configured for cooling the treated water and returning cooled treated water to the steelmaking plant for reuse;
a solar thermal system configured for collecting solar energy; and
an electric energy production system,
wherein the electric energy production system is configured for generating electricity from the solar energy and the waste heat, and
wherein the electric energy production system is further configured for using the generated electricity to power the wastewater treatment system and the water-cooling system.

2. The system of claim 1, wherein the water-cooling system is an indirect evaporative based water-cooling system.

3. The system of claim 1, further comprising a cooling water storage tank for storing cooled treated water from the water-cooling system.

4. The system of claim 1, wherein the solar thermal system comprises a plurality of solar thermal collectors.

5. The system of claim 1, wherein the at least one component is an electric arc furnace (EAF).

6. The system of claim 1, further comprising a power grid configured for storing excess energy from the electric energy production system.

7. The system of claim 1, wherein the generated electricity is provided proportionately to the wastewater treatment system and the water-cooling system.

8. The system of claim 1, wherein the generated electricity is provided disproportionately to the wastewater treatment system and the water-cooling system.

9. The system of claim 1, further comprising one or more valves for controlling a flow of at least one fluid within the system.

10. The system of claim 9, wherein the one or more valves are positioned between the solar thermal system and the electric energy production system.

11. The system of claim 9, further comprising a cooling water storage tank, wherein the one or more valves are positioned between the water-cooling system and the cooling water storage tank.

12. The system of claim 1, further comprising one or more valves for controlling transmission of electricity within the system.

13. The system of claim 12, further comprising a power grid, wherein the one or more valves are positioned between the electric energy production system and the power grid.

14. The system of claim 12, wherein the one or more valves are positioned between the electric energy production system and the water-cooling system.

15. A method for integrated water treatment and cooling in the steel industry, comprising:
receiving, with a waste heat recovery unit, waste heat generated by at least one component of a steelmaking plant;
treating, with a wastewater treatment system, wastewater produced by the steelmaking plant, thereby producing treated water;
cooling, with a water-cooling system, the treated water and returning cooled treated water to the steelmaking plant;
collecting solar energy with a solar thermal system;
generating electricity, with an electric energy production system, from the solar energy and the waste heat; and
using the generated electricity to power the wastewater treatment system and the water-cooling system.

16. The method of claim 15, further comprising storing, in a power grid, excess energy from the electric energy production system.

17. The method of claim 16, further comprising controlling transmission of electricity between the electric energy production system and the power grid using one or more valves.

18. The method of claim 15, wherein the generated electricity is provided proportionately to the wastewater treatment system and the water-cooling system.

19. The method of claim 15, wherein the generated electricity is provided disproportionately to the wastewater treatment system and the water-cooling system.

20. The method of claim 15, further comprising controlling a flow of at least one fluid between the solar thermal system and the electric energy production system using one or more valves.
